(19) United States
(12) Patent Application Publication
(10) Pub. No.: US 2024/0286897 A1
(43) Pub. Date: Aug. 29, 2024

(54) OZONE GENERATOR

(71) Applicant: Niterra Co., Ltd., Nagoya-shi, Aichi (JP)

(72) Inventors: Hideki HASUNUMA, Nagoya-shi (JP); Yoichi HATTORI, Nagoya-shi (JP)

(21) Appl. No.: 18/572,847

(22) PCT Filed: Mar. 24, 2022
(86) PCT No.: PCT/JP2022/013837

§ 371 Date: Dec. 21, 2023

(30) Foreign Application Priority Data
Jul. 2, 2021 (JP) 2021-110570

(51) Int. Cl. C01B 13/11

(52) U.S. Cl. CPC C01B 13/115; C01B 2201/14; C01B 2201/60

(57) ABSTRACT

An ozone generator (100) includes a flow passage (1) having a cylindrical shape, an ozone generating unit (3) disposed in the flow passage (1), and a fan (2) disposed in the flow passage (1). When a specific frequency f is one of frequencies at which an air-column resonance occurs in the flow passage (1), λ is a wavelength of sound at the specific frequency f, and m is a natural number, at least a portion of the fan (2) is disposed within a range in which a distance from the inlet (5) in a height direction is (2m−1)λ/8 or more and (2m+1)λ/8 or less.

### TECHNICAL FIELD

The present invention relates to an ozone generator.

### BACKGROUND ART

PTL 1 describes an ozone deodorization apparatus including an ozone generating device. The ozone deodorization apparatus includes a housing, the ozone generating device disposed in the housing, an air blowing device, a filtration device, and a control device. The inside of the housing is partitioned into a plurality of passages by a partition wall. The passages are provided with respective fans that can be driven independently.

### CITATION LIST

### Patent Literature

PTL 1: Japanese Unexamined Patent Application Publication No. 8-141059

### SUMMARY OF INVENTION

### Technical Problem

In an ozone generator including a fan, a reduction in the noise of the fan is desired. In this regard, when rapid disinfection and deodorization are required, the apparatus of PTL 1 increases the number of fans in operation to reduce the rotational speeds of the fans. However, the apparatus of PTL 1 cannot reduce the noise due to resonance, and there is room for improvement in terms of reducing the noise of the apparatus.

The present invention provides a technology for reducing the noise of an ozone generator.

### Solution to Problem

An ozone generator according to an aspect of the present invention includes a flow passage having a cylindrical shape, the flow passage allowing gas to flow from an inlet provided at one end side in a height direction to an outlet provided at another end side in the height direction; an ozone generating unit disposed in the flow passage; and a fan disposed in the flow passage. When λ is a wavelength of sound at a specific frequency at which an air-column resonance occurs in the flow passage and m is a natural number, at least a portion of the fan is disposed within a range in which a distance from the inlet in the height direction is (2m−1)λ/8 or more and (2m+1)λ/8 or less.

The above-described ozone generator is capable of reducing the resonance sound in the flow passage, and therefore the noise reduction effect can be enhanced.

In the above-described ozone generator, the ozone generating unit may be disposed downstream of the fan.

When the ozone generating unit is disposed downstream of the fan in the ozone generator, the ozone generated by the ozone generating unit can be diffused by the gas flow generated by the fan. Therefore, the ozone generator is capable of achieving both of noise reduction effect and uniformity of the ozone concentration.

In the above-described ozone generator, the fan may be disposed closer to the inlet than a center of the flow passage in the height direction.

Since the fan is disposed far from the outlet, the above-described ozone generator can have a long gas passage between the fan and the outlet. Accordingly, in the ozone generator, the intensity of the gas flow is not excessively increased around the outlet, so that the gas flow and the ozone concentration can be made further uniform.

### Advantageous Effects of Invention

According to the present invention, the noise of the ozone generator can be reduced.

### BRIEF DESCRIPTION OF DRAWINGS

FIG. 1 is a perspective view of an ozone generator.

FIG. 2 is a perspective view of a cross-section of the ozone generator.

FIG. 3 is a cross-sectional view of the ozone generator on a cross-section different from the cross-section in FIG. 2.

FIG. 4 is a perspective view of an ozone generating unit.

FIG. 5 illustrates the ozone generating unit viewed in a short-side direction.

FIG. 6 illustrates the ozone generating unit viewed in an aligning direction.

FIG. 7 is an exploded perspective view of the ozone generating unit.

FIG. 8 is a block diagram illustrating the electrical configuration of the ozone generator.

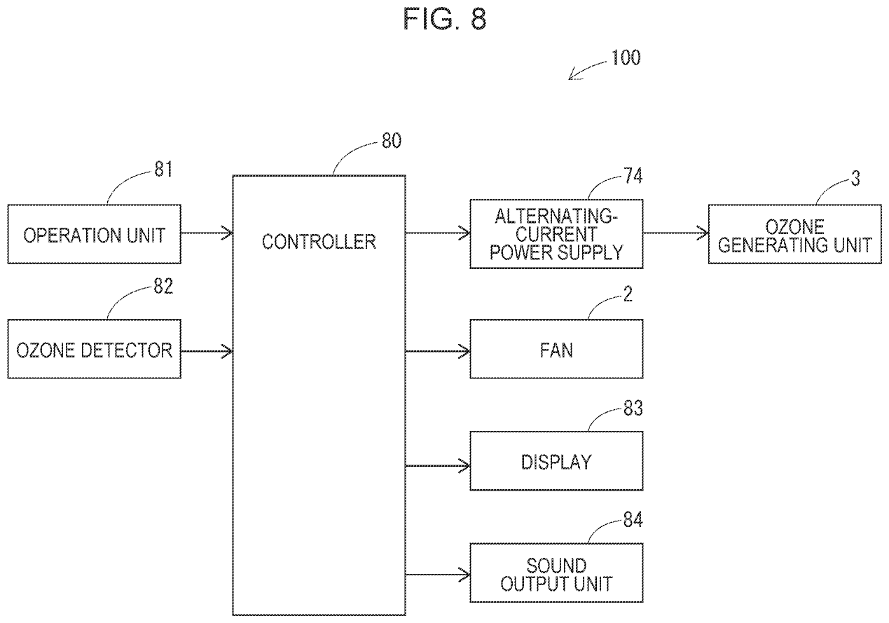

FIG. 9 illustrates the positional relationship between inlets and a fan in the ozone generator.

FIG. 10 is a graph comparing conversion spectra (spectra for comparison) obtained when a motor of the fan of the ozone generator is driven at different predetermined duties.

FIG. 11 is a graph comparing a conversion spectrum obtained when the fan is driven at a reference height (second position) and a conversion spectrum obtained when the fan is driven at a first position in which the height of the fan is different from that of the second position.

### DESCRIPTION OF EMBODIMENTS

### 1. First Embodiment

### 1-1. Basic Structure of Ozone Generator 100

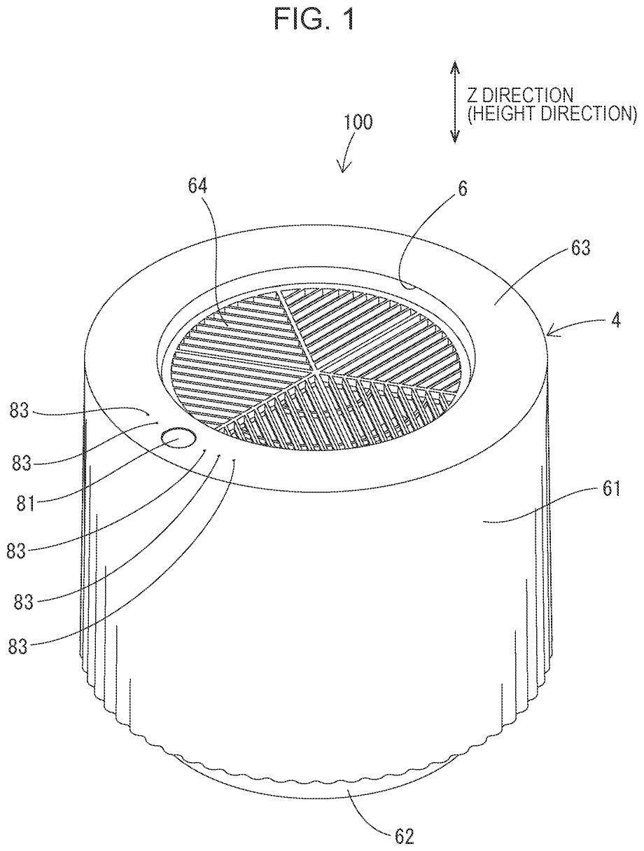

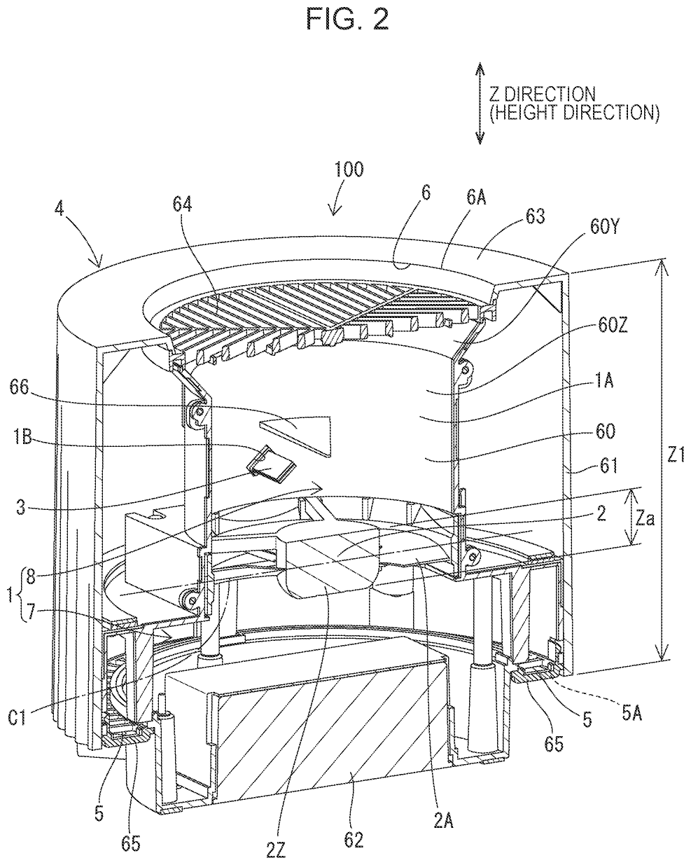

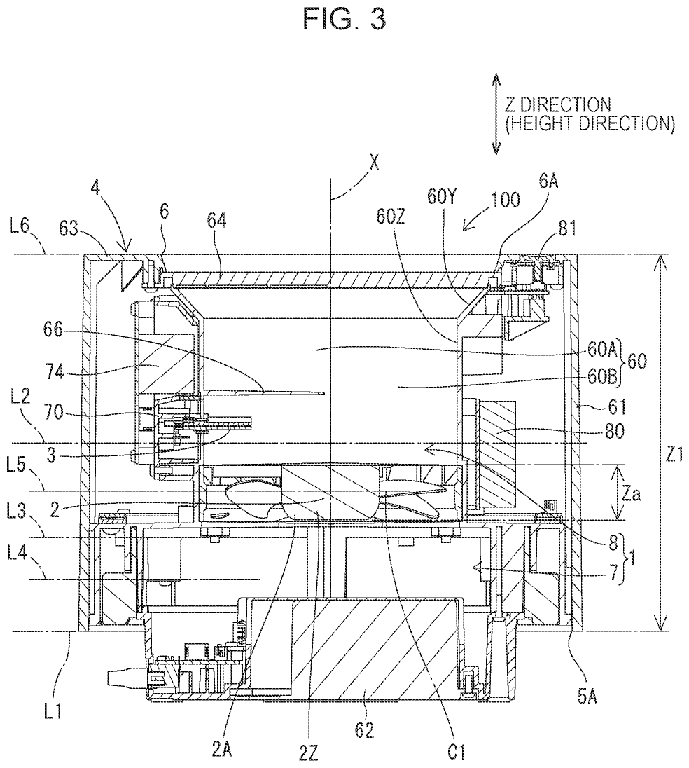

An ozone generator 100 illustrated in FIG. 1 is a device that takes in the outside air, creates a dielectric barrier discharge to generate ozone from oxygen in the air, and discharges the ozone to the outside. As illustrated in FIGS. 2 and 3, the ozone generator 100 mainly includes a flow passage 1 for gas, a fan 2, an ozone generating unit 3, a housing 4, and a finger guard 64.

As illustrated in FIG. 3, the flow passage 1 includes inlets 5 and an outlet 6. The inlets 5 are introduction openings through which gas (for example, air) outside the ozone generator 100 is introduced into the flow passage 1. The outlet 6 is a discharge opening through which gas in the flow passage 1 is discharged to the outside of the ozone generator 100. The flow passage 1 serves as a passage allowing the gas introduced through the inlets 5 to flow therethrough and be discharged from the outlet 6.

As illustrated in FIG. 3, the flow passage 1 extends in a height direction. In the following description, the height direction is also referred to as a Z direction or an up-down direction. In the following description, one end side in the height direction is a lower side, and the other end side in the height direction is an upper side. The inlets 5 are disposed at one end side in the height direction (lower end side in the present embodiment) and open toward the one end side in the height direction (downward in the present embodiment). The intake direction of the inlets 5 is a direction toward the other end side in the height direction (upward in the present embodiment). The outlet 6 is disposed at the other end side in the Z direction (upper end side in the present embodiment), and opens toward the other end side in the Z direction (upward in the present embodiment). The discharge direction of the outlet 6 is a direction toward the other end side in the Z direction (upward in the present embodiment).

As illustrated in FIG. 2, the inlets 5 are arranged in an annular shape (specifically, a round-ring shape) in which the axial direction is the height direction (Z direction). In the example illustrated in FIG. 2, the inlets 5 are formed by an inlet unit 65. The inlet unit 65 is a portion that forms the inlets 5, and has an annular shape. The inlet unit 65 is disposed between an inner periphery of a peripheral wall 61 on the lower end side and an outer periphery of a bottom portion 62 on the upper end side, and is engaged with respect to a flow passage unit 60. The inlet unit 65 has a plurality of the inlets 5. The plurality of the inlets 5 is arranged annularly along the annular inlet unit 65. The inlets 5 are each elongated in the radial direction.

As illustrated in FIGS. 2 and 3, the outlet 6 is disposed inward of the annular portion in which the inlets 5 are disposed. The outlet 6 has a circular shape.

As illustrated in FIG. 2, the flow passage 1 includes a first flow passage 7 and a second flow passage 8 disposed downstream of the first flow passage 7. The first flow passage 7 extends from the inlets 5 toward the outlet 6. The first flow passage 7 guides the gas introduced through the annularly arranged inlets 5 inwardly of the inner periphery of the inlets 5. The second flow passage 8 extends from a downstream end of the first flow passage 7 toward the outlet 6, that is, toward the other end side in the Z direction (upward in the present embodiment). The downstream end of the second flow passage 8 is connected to the outlet 6. The second flow passage 8 has an outer shape smaller than the inner periphery of the annularly arranged inlets 5, and guides the gas guided inward by the first flow passage 7 toward the outlet 6 (upward in the present embodiment) so that the gas is discharged through the outlet 6.

As illustrated in FIG. 2, the flow passage 1 is defined by an inner wall of the flow passage unit 60. The flow passage unit 60 is divided into a plurality of sections (two sections in the present embodiment) along the circumferential direction. More specifically, the flow passage unit 60 is divided into a first section 60A and a second section 60B in the circumferential direction. The first section 60A and the second section 60B are connected to each other.

As illustrated in FIG. 2, the housing 4 is a case containing various components including the flow passage unit 60, the fan 2, and the ozone generating unit 3. The housing 4 mainly includes the peripheral wall 61, the bottom portion 62, and a ceiling portion 63. The peripheral wall 61 has an annular shape (specifically a cylindrical shape, more specifically a round-cylindrical shape) and surrounds the outer peripheries of the flow passage unit 60 and the flow passage 1. The diameter of the outer periphery of the ozone generator 100 (outer diameter of the peripheral wall 61) is 225 mm, and the height of the ozone generator 100 is 204 mm.

The bottom portion 62 is a portion to be placed on a placement surface. The bottom portion 62 supports the flow passage unit 60 disposed above the bottom portion 62. The bottom portion 62 is shaped to be disposed inside the annularly arranged inlets 5. The bottom portion 62 has an outer shape smaller than the inner periphery of the peripheral wall 61.

The ceiling portion 63 is disposed on the other end side in the Z direction in the ozone generator 100, and has an annular shape in which the axial direction is the Z direction. The outlet 6 is formed inside the ceiling portion 63. The ceiling portion 63 has an outer periphery connected to an end of the peripheral wall 61 on the other end side (upper end in the present embodiment) and is formed integrally with the peripheral wall 61. The peripheral wall 61 and the ceiling portion 63 are disposed above the flow passage unit 60 with the finger guard 64 disposed therebetween, and are supported by the flow passage unit 60. The peripheral wall 61 is supported such that the peripheral wall 61 is raised above the placement surface.

As illustrated in FIG. 2, the finger guard 64 is a flat-shaped (disc-shaped in the present embodiment) member having a plurality of through holes. The through holes are each slit-shaped. The finger guard 64 has a function of preventing entrance of a foreign object (for example, a finger) from the outside while allowing the gas in the flow passage 1 to be discharged. The finger guard 64 is a member separate from the flow passage unit 60 and the ceiling portion 63. The finger guard 64 is disposed downstream of the diffusion plate 66.

The fan 2 is a device that generates a gas flow (specifically, a swirling flow) in the flow passage 1. In the present embodiment, the fan 2 is an axial fan. The fan 2 performs a blowing operation for delivering gas from the inlets 5 side of the flow passage 1 toward the outlet 6 side. The fan 2 includes a rotating body 2A and a motor. When electric power is supplied to the fan 2, the motor is driven to rotate the rotating body 2A, and thus the fan 2 performs the blowing operation. The fan 2 is disposed in the flow passage 1 (specifically, the second flow passage 8). The fan 2 is disposed with the axial direction of the fan 2 directed in the Z direction. The fan 2 rotates with the Z direction as the axis direction. The position of the fan 2 will be described in detail below.

### 1-2. Ozone Generating Unit 3

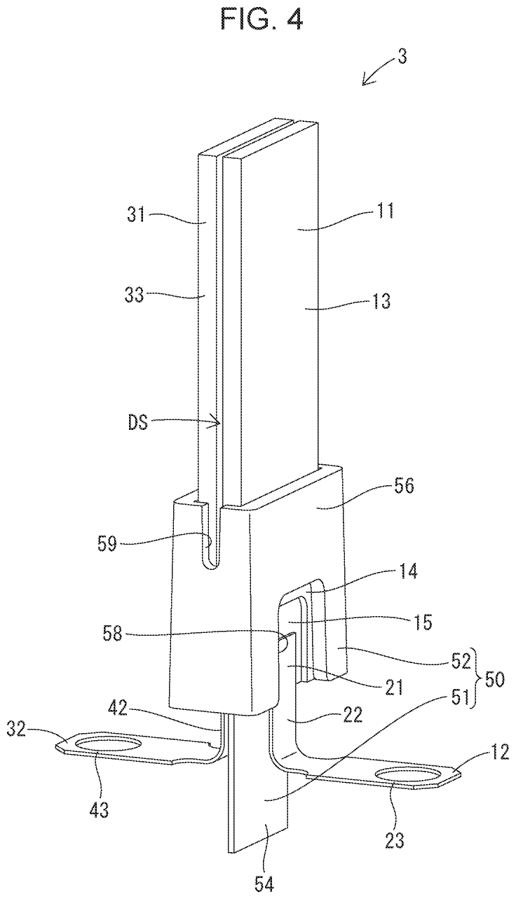

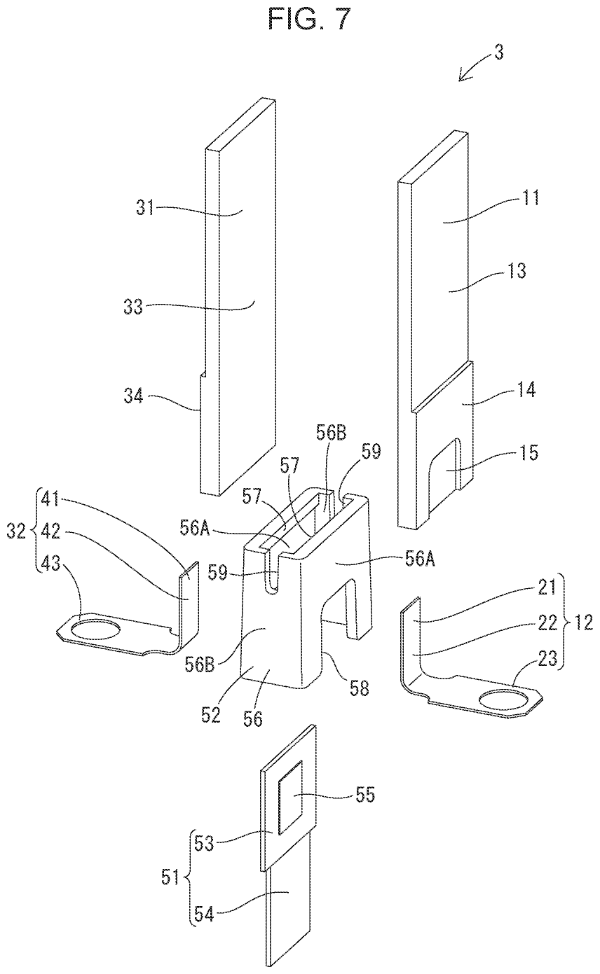

The ozone generating unit 3 creates a dielectric barrier discharge when an alternating-current voltage is applied thereto, and thereby generates ozone in the flow passage 1 by using oxygen in the air introduced through the inlets 5 as a material. As illustrated in FIGS. 4 to 7, the ozone generating unit 3 includes a first electrode 10, a second electrode 30, a first dielectric 11, a second dielectric 31, a first terminal 12, a second terminal 32, and a support unit 50.

The first electrode 10 and the second electrode 30 are made of a metal. In the present embodiment, tungsten (W) is used as the material. The material of the first electrode 10 and the second electrode 30 is not limited to tungsten, and may be, for example, molybdenum (Mo), silver (Ag), copper (Cu), or platinum (Pt). The first electrode 10 and the second electrode 30 are thin metal layers elongated in a predetermined direction.

In the present embodiment, the first dielectric 11 and the second dielectric 31 are formed using alumina (Al₂O₃) as the material. The material of the first dielectric 11 and the second dielectric 31 is not limited to alumina, and examples of the material also include other ceramics, such as glass (SiO₂), aluminum nitride (AlN) and yttrium oxide (Y₂O₃), and mixtures thereof. The first dielectric 11 covers the first electrode 10, and the second dielectric 31 covers the second electrode 30. The first dielectric 11 and the second dielectric 31 are each plate-shaped.

The first dielectric 11 and the second dielectric 31 are arranged in a thickness direction of the first dielectric 11 and the second dielectric 31. A discharge space DS is formed between the first dielectric 11 and the second dielectric 31. A thickness direction of the first electrode 10 and the second electrode 30 is the same as the thickness direction of the first dielectric 11 and the second dielectric 31.

The first electrode 10 is disposed in the first dielectric 11 at a position close to the second electrode 30 in an aligning direction of the first dielectric 11 and the second dielectric 31. The second electrode 30 is disposed in the second dielectric 31 at a position close to the first electrode 10 in the aligning direction. The first electrode 10 and the second electrode 30 are formed on upper surfaces of thin dielectric layers by, for example, printing. Then, thick dielectric layers are further formed on the first electrode 10 and the second electrode 30, so that the first dielectric 11 covering the first electrode 10 and the second dielectric 31 covering the second electrode 30 are produced.

The direction (long-side direction) in which the first electrode 10 and the second electrode 30 extend is the same as the long-side direction of the first dielectric 11 and the second dielectric 31 (hereinafter referred to simply as the “long-side direction”).

The first dielectric 11 includes a first dielectric body 13, a first protruding portion 14, and a first recess 15. The first dielectric body 13 is plate-shaped, and is rectangular parallelepiped-shaped. The first dielectric body 13 covers the first electrode 10. The first protruding portion 14 protrudes outside of the first dielectric 11 (to the side opposite to the second dielectric 31) on one end side in the length direction. The first recess 15 is formed in a surface of the first dielectric 11 facing outside (the side opposite to the second dielectric 31) on the one end side in the length direction.

The second dielectric 31 includes a second dielectric body 33, a second protruding portion 34, and a second recess 35. The second dielectric body 33 is plate-shaped, and is rectangular parallelepiped-shaped. The second dielectric body 33 covers the second electrode 30. The second dielectric body 33 faces the first dielectric body 13 to form the discharge space DS between the second dielectric body 33 and the first dielectric body 13. The second protruding portion 34 protrudes outside of the second dielectric 31 (to the side opposite to the first dielectric 11) on the one end side in the length direction. The second recess 35 is formed in a surface of the second dielectric 31 facing outside (the side opposite to the first dielectric 11) at the one end in the length direction.

The first terminal 12 and the second terminal 32 are each made of metal and plate-shaped. The first terminal 12 is disposed in the first recess 15, and the second terminal 32 is disposed in the second recess 35. The first terminal 12 is electrically connected to the first electrode 10, and the second terminal 32 is electrically connected to the second electrode 30.

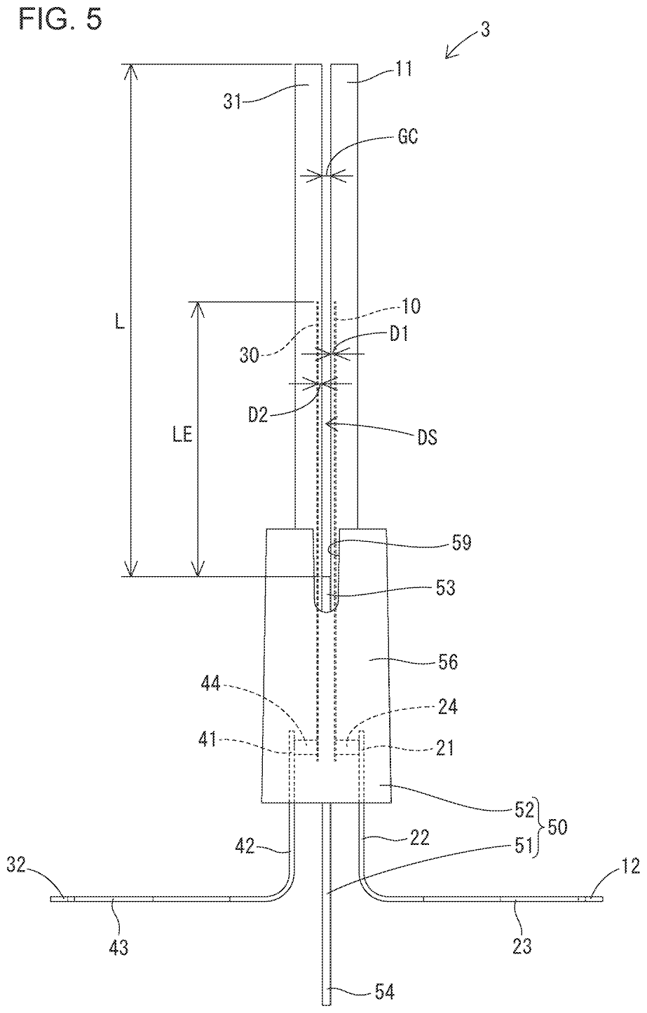

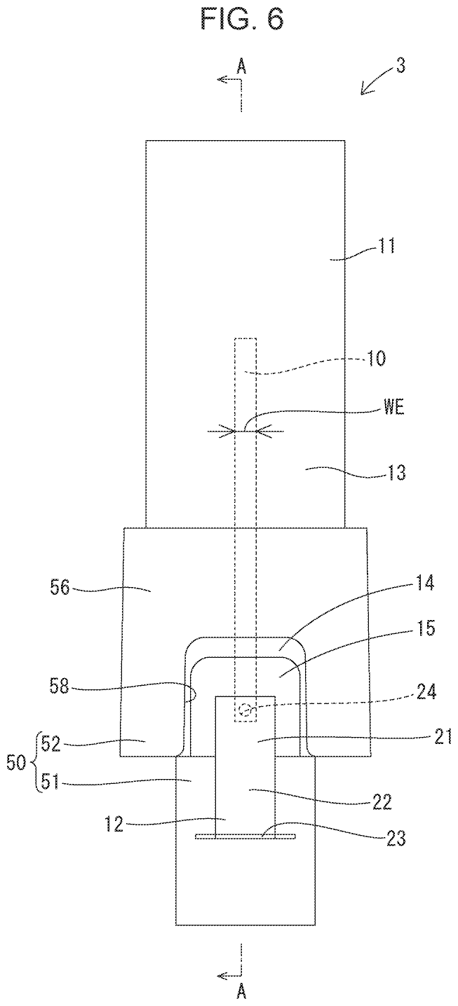

The first terminal 12 includes a first connecting portion 21; a first projecting portion 22 which is continuous with the first connecting portion 21 and projects further than the end of the first dielectric 11; and a third connecting portion 23 bent from the first projecting portion 22. As illustrated in FIGS. 5 and 6, the first connecting portion 21 is electrically connected to the first electrode 10 through a first conductive portion 24 provided in the first dielectric 11. Thus, the first terminal 12 is electrically connected to the first electrode 10.

The second terminal 32 includes a second connecting portion 41; a second projecting portion 42 which is continuous with the second connecting portion 41 and projects further than the end of the second dielectric 31; and a fourth connecting portion 43 bent from the second projecting portion 42. The second connecting portion 41 is electrically connected to the second electrode 30 through a second conductive portion 44 provided in the second dielectric 31. Thus, the second terminal 32 is electrically connected to the second electrode 30.

The support unit 50 supports the first dielectric 11 and the second dielectric 31 at the one end side in the length direction. The support unit 50 is formed using a resin (for example, polycarbonate (PC), ABS, PVC, or PP) as the material. The support unit 50 includes a spacer 51 and a holder 52.

The spacer 51 is plate-shaped, and is disposed between the first dielectric 11 and the second dielectric 31 at the one end side in the length direction, so that the discharge space DS is formed between the first dielectric 11 and the second dielectric 31 at the other end side in the length direction. The spacer 51 is provided with double-sided tapes 55 with which the first dielectric 11 and the second dielectric 31 are bonded. The first dielectric 11 and the second dielectric 31 are bonded to a spacer portion 53 of the spacer 51 with the double-sided tapes 55.

The holder 52 is a member for holding the first dielectric 11 and the second dielectric 31 having the spacer 51 therebetween, and surrounds the outer peripheries of the first dielectric 11 and the second dielectric 31 having the spacer 51 therebetween. In the holder 52, first cut portions 58 are formed to be cut out such that the first terminal 12 and the second terminal 32 are exposed. Second cut portions 59 are formed to be cut out such that the discharge space DS is exposed.

### 1-3. Electrical Configuration

An alternating-current power supply 74 includes a transformer, and is capable of supplying alternating-current electric power. The alternating-current power supply 74 generates the desired alternating-current electric power based on electric power supplied from a commercial power supply provided outside the ozone generator 100, and supplies the alternating-current electric power to, for example, the ozone generating unit 3.

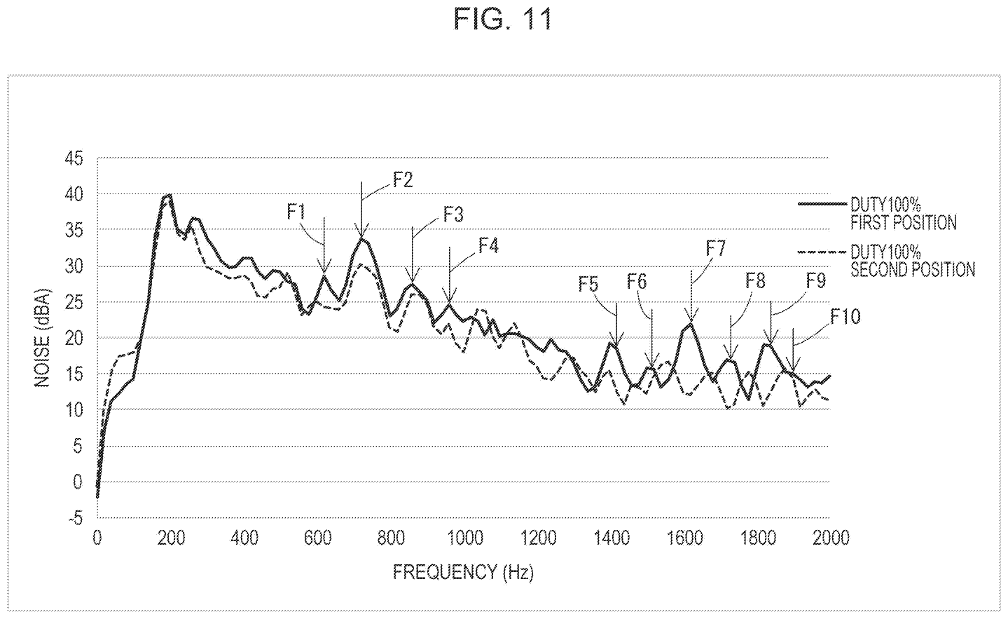

As illustrated in FIG. 11, the ozone generator 100 includes a controller 80, an operation unit 81, an ozone detector 82, a display 83, and a sound output unit 84. The controller 80 controls the operation of the ozone generator 100. The controller 80 is composed mainly of a microcomputer and includes a CPU, a ROM, a RAM, and a drive circuit.

The operation unit 81 is, for example, a switch that is switchable between on and off states when pressed, and may be a tactile switch, for example. A signal representing the result of the operation of the operation unit 81 is input to the controller 80. The ozone detector 82 detects the ozone concentration in the air outside the ozone generator 100. A signal representing the detection value obtained by the ozone detector 82 is input to the controller 80.

The controller 80 is capable of controlling the operation of the ozone generating unit 3 via the alternating-current power supply 74. The controller 80 is capable of adjusting the amount of ozone generated by the ozone generating unit 3 by controlling the alternating-current voltage applied to the ozone generating unit 3. The controller 80 may adjust the amount of ozone generated by the ozone generating unit 3 based on the result of the operation of the operation unit 81. The controller 80 may perform feedback control of the operation of the ozone generating unit 3 so that the ozone concentration approaches a target value based on the ozone concentration detected by the ozone detector 82.

The controller 80 is capable of controlling the operation of the fan 2. The controller 80 performs PWM control of the fan 2 by applying a PWM signal to the fan 2. Thus, the controller 80 is capable of adjusting the blowing volume.

The controller 80 is capable of controlling the operation of the display 83. The display 83 includes, for example, LED lamps. The display 83 shows the on/off state of the power supply, the operational state of the fan 2, the ozone concentration in the outside air, etc., based on the lighting state of the LED.

The controller 80 is capable of controlling the operation of the sound output unit 84. The sound output unit 84 outputs sound, and may be, for example, a buzzer. The sound output unit 84 outputs a warning sound when, for example, there is an abnormality in the ozone generator 100.

### 1-4. Arrangement of Fan 2

In FIGS. 2 and 3, the height (length in the height direction) of the flow passage 1 is denoted by Z1. The range in which a driving unit 2Z is disposed in the height direction is denoted by Za. As illustrated in FIGS. 2 and 3, the flow passage 1 has a cylindrical shape, and serves as a passage allowing gas to flow from the inlets 5 provided at the one end side in the height direction to the outlet 6 provided at the other end side in the height direction. The ozone generating unit 3 and the fan 2 are disposed in the flow passage 1.

In a region downstream of the fan 2, a cylindrical portion 60Z is provided in a majority of the region in the height direction. The cylindrical portion 60Z has a cylindrical shape having a center axis X at the center, and an inner wall of the cylindrical portion 60Z constitutes an inner wall of the flow passage 1. The inner wall surface of the cylindrical portion 60Z is a round cylindrical surface with a predetermined radius having the center axis X at the center and is a smooth surface. On the other end side (upper side) in the height direction with respect to the cylindrical portion 60Z, an expanding portion 60Y having an inner diameter gradually increasing toward the other end side in the height direction is provided. The expanding portion 60Y is continuous with the cylindrical portion 60Z. In FIG. 3, the lower end of the expanding portion 60Y coincides with the upper end of the cylindrical portion 60Z. The upper end of the expanding portion 60Y corresponds to the outlet 6. An upper end 6A of the outlet 6 is the upper end of the flow passage 1.

A portion of the fan 2 including a motor (not illustrated) and the rotating body 2A serves as the driving unit 2Z. In FIG. 3, the range of the driving unit 2Z in the height direction is denoted by Za. The fan 2 is disposed close to a lower end of the cylindrical portion 60Z. The rotating body 2A rotates around the center axis X.

In FIG. 3, a straight line L1 shows the position of one end in the height direction (lower end 5A) of the inlet 5 in the flow passage 1. A straight line L2 shows the position of the center of the flow passage 1 in the height direction. A straight line L3 shows the position in the flow passage 1 that is separated from the one end in the height direction (lower end 5A) of the inlet 5 toward the other end side in the height direction (upper side) by ¼×Z1 in the height direction. A straight line L4 shows the position that is separated from the lower end 5A toward the other end side in the height direction (upper side) by ⅛×Z1 in the height direction, and a straight line L5 shows the position that is separated from the lower end 5A toward the other end side in the height direction (upper side) by ⅜×Z1. A straight line L6 shows the position of the other end in the height direction (upper end 6A) of the outlet 6 in the flow passage 1.

In the example illustrated in FIG. 3, at least a portion of the ozone generating unit 3 is disposed in the cylindrical portion 60Z. In other words, the ozone generating unit 3 is disposed downstream of the fan 2 in the flow passage 1. The fan 2 is disposed closer to the inlets 5 (FIG. 2) than the center of the flow passage 1 in the height direction (position of the straight line L2). More specifically, the entirety of the driving unit 2Z of the fan 2 is disposed closer to the inlets 5 (FIG. 2) than the center of the flow passage 1 in the height direction (position of the straight line L2).

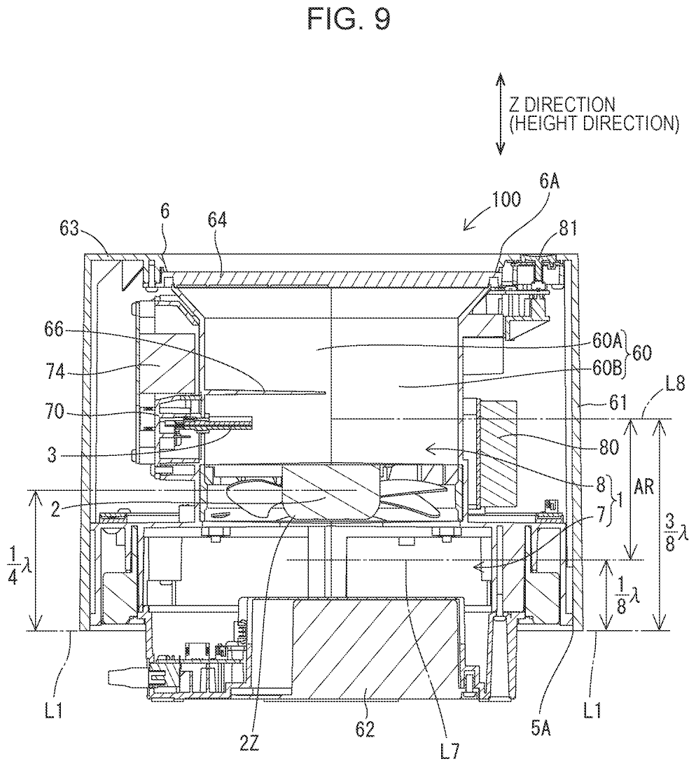

More specifically, the fan 2 is positioned as illustrated in FIG. 9. To determine the position, one of the frequencies at which an air-column resonance occurs in the flow passage 1 is defined as a specific frequency f. The specific frequency f (Hz) may be any frequency at which an air-column resonance occurs in the flow passage 1. When the specific frequency f is determined, the wavelength of sound at the specific frequency f is defined as λ (m). In this case, at least a portion of the fan 2 is disposed within a range AR in which the distance from the inlets 5 in the height direction (specifically, the distance from the lower end 5A in the height direction) is (2m−1)λ/8 or more and (2m+1)λ/8 or less. In the above expressions, m is a natural number. FIG. 9 illustrates the structure of FIG. 3 from another standpoint. FIG. 9 illustrates an example in which a certain specific frequency f is selected and in which m=1. In FIG. 9, λ is a wavelength determined as λ=c/f when c (m/s) is the speed of sound in air at a room temperature of 15° C.

In the example illustrated in FIG. 9, the entirety of the driving unit 2Z of the fan 2 is disposed within the above-described range AR in the height direction. For example, the center of the driving unit 2Z in the height direction is positioned at a distance of ¼×λ from the lower end 5A in the height direction.

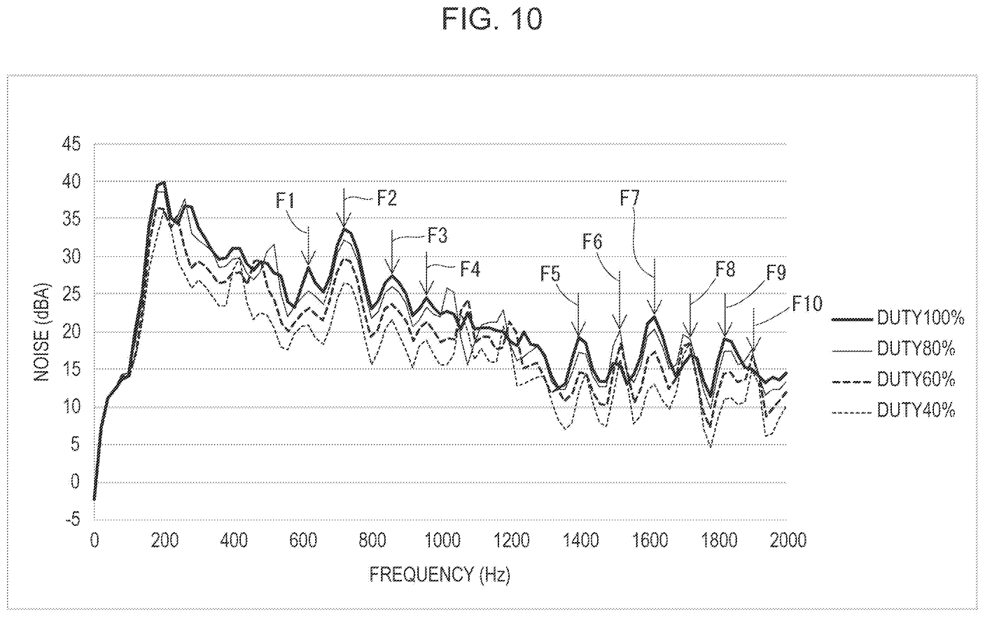

The specific frequency f may be a value defined as described below. In the ozone generator 100, assume that a sound waveform (horizontal axis representing time and vertical axis representing noise level) obtained when noise is measured at a position 1000 mm away from the ozone generator 100 by a method according to JIS (JIS Z 8731) is a “measurement waveform”. This “measurement waveform” is converted by performing FFT into a frequency spectrum (frequency spectrum with the horizontal axis representing frequency and the vertical axis representing noise level), and the converted frequency spectrum is defined as a “conversion spectrum”. When the “conversion spectrum” is thus defined and the motor of the fan 2 is driven at different duties (specifically, 40%, 60%, 80%, and 100%), the “conversion spectra” (frequency spectra) obtained by driving at each duty are defined as “spectra for comparison”. FIG. 10 shows a plurality of “spectra for comparison” obtained when the motor of the fan 2 is driven at each duty (40%, 60%, 80%, and 100%) in the structure of the first embodiment. In thus-obtained “spectra for comparison”, frequencies at which peak positions are not varied are determined as “candidate frequencies”. In the example illustrated in FIGS. 10, F1 to F10 indicate the “candidate frequencies”. The “frequencies at which peak positions are not varied” may be a frequency at which all of the “spectra for comparison” have their peak positions (frequency at which the peak positions coincide). Alternatively, when all of the “spectra for comparison” have their peak positions whose frequencies are within differences of 1 Hz or less (that is, when all of the “spectra for comparison” have their peak positions whose frequencies are close to each other and the difference between the highest and lowest frequencies is 1 Hz or less), one of the frequencies that differ by 1 Hz or less may be regarded as a “frequencies at which peak positions are not varied” (that is, a candidate frequency).

Furthermore, when a height adjustment is performed to change the height from the inlets 5 to the fan 2 in the ozone generator 100, the motor of the fan 2 is driven at one of the duties (for example, 100%) to obtain the “conversion spectrum” at each height of the fan 2. The “conversion spectra” obtained at different heights are compared with each other, and some of the above-described “candidate frequencies” at which the peak positions are shifted are selected as “frequencies at which an air-column resonance occurs”. One of the thus-selected “frequencies at which an air-column resonance occurs” is defined as the “specific frequency”. When the “height adjustment” is performed, each “conversion spectrum” can be obtained as described below. More specifically, assuming that the height of the fan 2 in the ozone generator 100 illustrated in FIG. 3 is a reference height (0 mm), the height of the fan 2 from the inlets 5 is changed to different heights such that the fan 2 moves from the reference height toward the outlet 6 side in steps of 5 mm, and the fan 2 is driven at each height to obtain the “conversion spectrum”. The height adjustment and the creation of the conversion spectrum are repeated at least until a frequency at which the peak position is shifted is found among the “candidate frequencies”. In this case, “peak position is not shifted” means that the frequency corresponding to the peak position is not shifted (changed) by more than 1 Hz, and “peak position is shifted” means that the frequency corresponding to the peak position is shifted (changed) by more than 1 Hz.

FIG. 11 illustrates an example in which the “conversion spectra” are obtained as described above. In the graph of FIG. 11, the bold solid line shows the “conversion spectrum” obtained when the fan 2 is at a second position as in the ozone generator 100 illustrated in FIG. 3 (position at the reference height) and when the motor of the fan 2 is driven at a duty of 100%. In addition, in the graph of FIG. 11, the dashed line shows the “conversion spectrum” obtained when the fan 2 is at a first position different from the above-described second position and when the motor of the fan 2 is driven at a duty of 100%. At the first position, the height of the fan 2 is changed from that at the second position (position at the reference height) by 5 mm or more, and a peak position is shifted from that at the second position at one or more of the “candidate frequencies”. In the example illustrated in FIG. 11, among the “candidate frequencies”, the peaks at the “candidate frequencies” denoted by F1 to F4 are not changed; therefore, these “candidate frequencies” are not selected as the “specific frequency”. Among the “candidate frequencies”, the peaks at the “candidate frequencies” denoted by F5 to F10 are shifted; therefore, one of these “candidate frequencies” can be selected as the “specific frequency”.

### 1-5. Effect of First Embodiment

The ozone generator 100 is capable of reducing the resonance sound in the flow passage 1, and therefore the noise reduction effect can be enhanced.

In the ozone generator 100, the ozone generating unit 3 is disposed downstream of the fan 2, so that the ozone generated by the ozone generating unit 3 can be diffused by the gas flow generated by the fan 2. Therefore, the ozone generator 100 is capable of achieving both of noise reduction effect and uniformity of the ozone concentration.

In the ozone generator 100, the fan 2 is disposed closer to the inlets 5 than the center of the flow passage 1 in the height direction. Since the fan 2 is far from the outlet 6, the ozone generator 100 can have a long gas passage between the fan 2 and the outlet 6. Accordingly, in the ozone generator 100, the intensity of the gas flow is not excessively increased around the outlet 6, so that the gas flow and the ozone concentration can be made further uniform.

### OTHER EMBODIMENTS

The present invention is not limited to the embodiment described above with reference to the drawings. For example, embodiments described below are also included in the technical scope of the present invention. The features of the above-described embodiment and the embodiments described below may be combined in any way as long as there is no contradiction.

Although an example of a method for determining λ is described above in the embodiment, the method is not limited thereto. For example, the flow passage 1 may be regarded as an open tube having free ends at the top and bottom, and λ may be calculated as λ=2×Z1/n. In this equation, n is a natural number of 2 or more. When, for example, n=2 in the structure illustrated in FIG. 3 (when double vibration is considered), at least a portion of the fan 2 can be disposed in the range from the straight line L4 to the straight line L5.

Although the Z direction is the up-down direction in the above-described embodiment, the Z direction is not limited to the up-down direction. For example, the Z direction may be a direction inclined with respect to the up-down direction.

Although the support unit supports the first and second dielectrics at one end side thereof in the above-described embodiment, the support unit may support the first and second dielectrics at both end sides thereof.

Although the first and second dielectrics are supported by the support unit at the ends thereof at the same side in the above-described embodiment, it is not necessary that the supported ends thereof be at the same side. For example, the first and second dielectrics may be supported at the ends thereof on the alternately opposite sides.

It is to be understood that the embodiments disclosed herein are examples and not restrictive in all respects. The scope of the present invention is not limited to the embodiments disclosed herein, and is intended to include all modifications within the scope defined by the claims or the scope equivalent to the scope of the claims.

### REFERENCE SIGNS LIST

1 flow passage
2 fan
3 ozone generating unit
4 housing
5 inlet
6 outlet
100 ozone generator

What is claimed is:

1. An ozone generator comprising:
a flow passage having a cylindrical shape, the flow passage allowing gas to flow from an inlet provided at one end side in a height direction to an outlet provided at another end side in the height direction;
an ozone generating unit disposed in the flow passage; and
a fan disposed in the flow passage,
wherein when λ is a wavelength of sound at a specific frequency at which an air-column resonance occurs in the flow passage and m is a natural number, at least a portion of the fan is disposed within a range in which a distance from the inlet in the height direction is (2m−1)λ/8 or more and (2m+1)λ/8 or less.

2. The ozone generator according to claim 1, wherein the ozone generating unit is disposed downstream of the fan.

3. The ozone generator according to claim 1, wherein the fan is disposed closer to the inlet than a center of the flow passage in the height direction.

4. The ozone generator according to claim 2, wherein the fan is disposed closer to the inlet than a center of the flow passage in the height direction.
